(19) United States
(12) Patent Application Publication
(10) Pub. No.: US 2013/0179577 A1
(43) Pub. Date: Jul. 11, 2013

(54) SYSTEMS, METHODS, AND DEVICES FOR SELECTING A CONTENT DELIVERY METHOD BASED ON DEMAND FOR PARTICULAR CONTENT BY CUSTOMERS

(71) Applicant: Telcom Ventures, L.L.C., Miami, FL (US)

(72) Inventors: Rajendra Singh, Indian Creek Village, FL (US); Hersh Singh, Indian Creek Village, FL (US)

(73) Assignee: Telcom Ventures, L.L.C., Miami, FL (US)

(21) Appl. No.: 13/734,269

(22) Filed: Jan. 4, 2013

Related U.S. Application Data
(60) Provisional application No. 61/583,397, filed on Jan. 5, 2012.

(51) Int. Cl. H04L 29/06

(52) U.S. Cl. CPC H04L 65/60
USPC 709/226

(57) ABSTRACT

Processes of selecting a content delivery method may include selecting between first and second content delivery methods for a particular media content in response to demand for the particular media content by a plurality of customers. Related systems and devices are also described.

### CLAIM OF PRIORITY

The present application claims the benefit of U.S. Provisional Patent Application Ser. No. 61/583,397, filed Jan. 5, 2012, entitled Systems, Methods, and Devices for Selecting a Content Delivery Method Based on Demand for Particular Content by a Plurality of Customers, the disclosure of which is incorporated herein in its entirety by reference.

### FIELD

The present disclosure relates to content delivery, and more particularly to systems, methods, and devices for selecting a content delivery method.

### BACKGROUND

A content provider can deliver media content to end users through a variety of different methods. For example, media content can be delivered by physical (rather than electronic) mail (e.g. by mailing a Digital Versatile Disc (DVD) or a Compact Disc (CD)), by the Internet, by using a digital television (TV) broadcast channel, or by using a forward link of a mobile (e.g., cellular) network. Additionally, different items of media content may have different levels of demand, and it may be possible to determine the demand from a group of end users for particular items of media content. For example, a content provider can electronically receive requests for particular media content from a plurality of end users in real-time, or nearly in real-time, via the Internet, via text messaging (e.g., Short Message Service (SMS)) using a mobile network, and/or via a telephone call center.

One example of selecting a method of delivery for media content is U.S. Patent Application Publication No. 2011/0153856 to Piepenbrink et al., entitled Method and System for Selecting a Delivery Method For Media on Demand, which describes selecting a method of delivery based on connection speed. Additionally, examples of processing media requests are provided in U.S. Pat. No. 7,742,949 to Evangelist et al., entitled System and Method for Processing Media Requests; and U.S. Pat. No. 7,996,265 to Evangelist et al., entitled System and Method for Fulfilling a Media Request. In another example, Choosing a Content Delivery Method (http://www.business.att.com/content/whitepaper/WP-con_{—}16674_v2_{—}7-2-08 .pdf)(July 2008) describes network-based, cache-based content distribution networks. In a further example, Cisco Content Delivery Applications for Internet Streaming (Version 2.5) (http://www.cisco.com /en/US/prod/collateral/video/ps7191/ps7127/product_data_sheet0900aecd806a40f3.pdf)(April 2010) describes caching high-demand content.

### SUMMARY

According to some embodiments herein, processes of selecting a content delivery method may include selecting between first and second content delivery methods for a particular media content in response to demand for the particular media content by a plurality of customers. Moreover, in some embodiments, a content delivery system or device may be configured to perform the processes described herein.

In some embodiments, the demand for the particular media content may be determined in response to a number (e.g., quantity) of requests for the particular media content by the plurality of customers. Additionally or alternatively, the demand for the particular media content may be determined in response to preferences of the plurality of customers for how quickly the particular media content is delivered. The second content delivery method may be a substantially time-delayed delivery method in comparison with the first content delivery method. In some embodiments, the first and second content delivery methods may use a different physical medium. For example, the first and second content delivery methods may include different methods among physical mail, Internet delivery, a television channel, or a forward link of a mobile network.

According to some embodiments, selecting between the first and second content delivery methods may include selecting the first content delivery method for a first portion of the particular media content and selecting the second content delivery method for a second portion of the particular media content. For example, the processes may include delivering the first and second portions of the particular media content via the first and second content delivery methods, respectively, to an electronic device of one of the plurality of customers that is configured to reassemble (e.g., connect, combine) the first and second portions of the particular media content to provide an entirety of the particular media content. As an example, the first content delivery method may include Internet delivery and the second content delivery method may include a television channel. As another example, the first content delivery method may include Internet delivery and the second content delivery method may include a forward link of a mobile network.

In some embodiments, the particular media content may include a first media content. The processes may further include delivering the first and second portions of the first media content via the first and second content delivery methods, respectively, and delivering a second media content exclusively via a third content delivery method in response to demand for the first and second media content. Demand for the second media content that is delivered exclusively via the third content delivery method may be higher than demand for the first media content that is delivered in the first and second portions via the first and second content delivery methods, respectively. According to some embodiments, the first and third content delivery methods may include a same delivery method, and the first and second delivery methods include different delivery methods. Alternatively, the first, second, and third content delivery methods may include different delivery methods, respectively.

Some embodiments provide that selecting between the first and second content delivery methods may include determining the demand for the particular media content, and determining the demand for the particular media content may include differentiating between premium and non-premium ones of the plurality of customers. Differentiating between premium and non-premium ones of the plurality of customers may include weighting the premium ones of the plurality of customers more heavily than the non-premium ones of the plurality of customers with respect to determining the demand for the particular media content. Moreover, determining the demand for the particular media content may include determining whether a threshold number (e.g., quantity) of the premium ones of the plurality of customers have requested the particular media content.

Processes of selecting a content delivery method, according to some embodiments herein, may include electronically receiving a plurality of requests from a plurality of customers, respectively, for first media content and/or second media content. The processes may include comparing demand for the first media content by the plurality of customers with demand for the second media content by the plurality of customers using the plurality of requests. The processes may include selecting a first content delivery method for the first media content in response to determining that the demand for the first media content is greater than the demand for the second media content. The processes may include selecting a second content delivery method for the second media content. Moreover, in some embodiments, a content delivery system or device may be configured to perform the processes described herein.

In some embodiments, comparing demand may include comparing a quantity of the plurality requests that are for (i.e., that correspond to) the first media content with a quantity of the plurality of requests that are for the second media content. Also, the processes may include electronically delivering (e.g., broadcasting/multicasting/presenting/playing on a television channel, the Internet, and/or a mobile network) the first and second media content during respective time periods that at least partially overlap. Some embodiments provide that the processes may further include determining whether the quantity of the plurality of requests that are for the first media content meets (or exceeds) a threshold number corresponding to the first content delivery method. Moreover, comparing demand may further include determining: a quantity of the plurality of requests that are from premium ones of the plurality customers; and/or a quantity of the plurality of requests that are from ones of the plurality of customers urgently requesting the first media content and/or the second media content. Selecting the first content delivery method thus may further include selecting the first content delivery method for the first media content in response to determining the quantity of the plurality of requests from premium ones of the plurality of customers and/or the quantity of the plurality of requests from ones of the plurality of customers urgently requesting the first media content and/or the second media content.

In some embodiments, selecting the first content delivery method for the first media content may further include selecting the first content delivery method for the first media content in response to determining that a quality of service that can be provided with respect to the first media content for one or more of the plurality of customers meets (or exceeds) a threshold. The processes may further include, after delivering at least a portion of the first media content via the first content delivery method, receiving real-time feedback regarding a quality of service received by one or more of the plurality of customers with respect to the delivery of the first media content. The processes may include selecting a content delivery method that is different from the first content delivery method for the first media content for the one or more of the plurality of customers in response to determining from the real-time feedback that the quality of service fails to meet (or exceed) a threshold.

Processes of selecting first and second video content delivery methods, according to some embodiments, may include receiving requests for first video content and requests for second video content from a plurality of customers. The processes may include determining demand for the first video content and demand for the second video content using the plurality of requests. The processes may include selecting first and second video content delivery methods for the first and second video content, respectively, in response to the demand for the first video content and the demand for second video content by the plurality of customers. In some embodiments, the processes may include electronically delivering the first and second video content during respective time periods that at least partially overlap. Additionally or alternatively, the processes may include selecting the first and second video content delivery methods for the first and second video content, respectively, in response to determining that selecting the first video content delivery method for the first video content is more cost-effective for a content provider of the first video content than selecting the second video content delivery method for the first video content. Moreover, in some embodiments, a content delivery system or device may be configured to perform the processes of selecting first and second video content delivery methods.

According to some embodiments, selecting first and second video content delivery methods for the first and second video content, respectively, may include prioritizing delivery of the first video content over the second video content in response to determining that the demand from the first video content is greater than the demand for the second video content. The first video content may include a movie or a television (TV) program and the second video content may include a different movie or TV program. The first video content delivery method may include a TV channel and the second video content delivery method may include Internet delivery and/or a forward link of a mobile network. In some embodiments, delivering the second video content may include delivering a portion of the second video content via the second video content delivery method during the partial overlap of the time periods and delivering a different portion of the second video content via the TV channel either before or after the partial overlap of the time periods.

Some embodiments provide that determining the demand for the first video content and determining the demand for the second video content may include determining numbers (e.g., quantities) of requests for the first and second video content, respectively. Moreover, determining the demand for the first video content and determining the demand for the second video content may further include determining numbers (e.g., quantities) of premium customers requesting the first and second content, respectively and/or determining an urgency of the requests for the first video content and an urgency of the requests for the second video content. Additionally or alternatively, determining the demand for the first video content and determining the demand for the second video content may further include determining which of the plurality of customers is capable of receiving video content via both of the first and second video content delivery methods.

### BRIEF DESCRIPTION OF THE DRAWINGS

FIG. 1A is a schematic diagram illustrating selecting a content delivery method based on demand for particular content by a plurality of customers, according to various embodiments described herein.

FIG. 1B is a block diagram that illustrates details of an exemplary processor and memory that may be used in accordance with various embodiments described herein.

FIGS. 2-4 are flowcharts illustrating selecting a content delivery method based on demand for particular content by a plurality of customers, according to various embodiments described herein.

FIG. 5 is a schematic diagram illustrating content delivery via two different methods, according to various embodiments herein.

FIG. 6 is a schematic diagram illustrating content delivery of different portions of a movie via two different methods, according to various embodiments herein.

### DETAILED DESCRIPTION

Specific embodiments of the invention now will be described with reference to the accompanying drawings. This invention may, however, be embodied in a variety of different forms and should not be construed as limited to the embodiments set forth herein. Rather, these embodiments are provided so that this disclosure will be thorough and complete, and will fully convey the scope of the invention to those skilled in the art. In the drawings, like designations refer to like elements. It will be understood that when an element is referred to as being “connected,” “coupled,” or “responsive” to another element, it can be directly connected, coupled or responsive to the other element or intervening elements may be present. Furthermore, “connected,” “coupled,” or “responsive” as used herein may include wirelessly connected, coupled or responsive.

The terminology used herein is for the purpose of describing particular embodiments only and is not intended to be limiting of the invention. As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. The symbol “/” is also used as a shorthand notation for “and/or.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that although the terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of the present invention. Moreover, it will be understood that when an operation herein is described as being “based on” something, the operation may be understood to directly or indirectly process/use the particular thing/data and/or be directly or indirectly responsive to the particular thing/data.

The present invention is described in part below with reference to block diagrams and flowcharts of methods, systems, devices, and computer program products according to embodiments of the invention. A given block or blocks of the block diagrams and/or flowcharts provides support for methods, devices, computer program products, and/or systems.

For example, it will be understood that each block (of the flowcharts and block diagrams), and combinations of blocks, can be implemented by computer program instructions. These program instructions may be provided to a processor circuit, such as a microprocessor, microcontroller, or other processor, such that the instructions which execute on the processor(s) create means for implementing the functions specified in the block or blocks. The computer program instructions may be executed by the processor circuit(s) to cause a series of operational steps to be performed by the processor circuit(s) to produce a computer implemented process such that the instructions which execute on the processor circuit(s) provide steps for implementing the functions specified in the block or blocks.

It should also be noted that in some alternate implementations, the functions/acts noted in the flowcharts may occur out of the order noted in the flowcharts. For example, two blocks shown in succession may in fact be executed substantially concurrently or the blocks may sometimes be executed in the reverse order, depending upon the functionality/acts involved. Finally, the functionality of one or more blocks may be separated and/or combined with that of other blocks.

Selecting Between Different Content Delivery Methods May Improve Efficiency

Different methods of content delivery may be more or less suitable in a given situation depending on the profile (e.g., status and/or device capabilities) of end users and/or the demand for particular content. For example, on a given day, a first movie (e.g., a new movie release) and a second movie (e.g., an older movie) may have different levels of demand from end users (e.g., customers/subscribers of a content provider). In one example, fifty (50) end users may electronically request (e.g., via the Internet, SMS, a call center, etc.) to watch the new movie release, and ten (10) end users may request to watch the older movie. The content provider may have several methods of content delivery at its disposal, such as (1) delivering the content via a digital TV broadcast channel, (2) delivery via the Internet (e.g., by live streaming or by download), (3) delivery via a mobile network, and (4) delivery via physical mail (e.g., government-based or privately-owned envelope or parcel delivery). However, it may be costly and/or logistically challenging for the content provider to deliver multiple content items using a particular one of these content delivery methods at a given time.

Additionally, some of the end users may not have the capability to receive the content via each of the methods of content delivery. For example, all but five (5) of the fifty (50) end users requesting the new movie release may have the capability to receive the new movie release using any of the methods of content delivery. In other words, as an example, these five (5) end users might only be able to receive the new movie release by mail. On the other hand, all ten (10) of the end users requesting the older movie may have the capability to receive the older movie by any of the different content delivery methods. Accordingly, the content provider must select (A) a content delivery method for the forty-five (45) end users that requested the new movie release and that can receive the new movie release by more than just mail and (B) a content delivery method for the ten (10) end users that requested the older movie.

For example, the content provider may choose to deliver the new movie release over the digital TV broadcast channel in real time to the forty-five (45) end users that requested the new movie release and that can receive the new movie release by more than just mail; to deliver the new movie release by mail to the five (5) end users that requested the new movie release but that can only receive the new movie release by mail; and to deliver the older movie via the Internet to the ten (10) end users that requested the older movie. According to various embodiments described herein, the content provider may select the content delivery methods based on one or more criteria. As an example, the content provider may select the content delivery methods based exclusively on the number (i.e., quantity) of end users requesting particular content. As such, in this case of forty-five (45) end users requesting (and capable of receiving) the new movie release and only ten (10) end users requesting the older movie, the content provider will choose to broadcast the new movie release on the digital TV channel (i.e., the higher priority/quality delivery method) and to deliver the older movie via the Internet (i.e., the lower priority/quality delivery method). In particular, the demand for the new movie release is higher, and the different delivery methods for the new movie release and the older movie are selected because of the different levels of demand. Accordingly, one criteria for selecting delivery content methods based on demand is determining which content has received the most end user requests.

Additionally or alternatively, the content provider can select the content delivery methods based on other criteria, such as based on the profile of the end users requesting the content. For example, the content provider may defer to preferred end users (e.g., end users who have a premium membership and expect a superior method of content delivery because they are willing to pay more for uninterrupted real-time content) by determining a weighted average for the end users based on whether the end users are premium or non-premium end users. As an example, premium end users may carry twice the weight of non-premium end users with respect to determining demand. Additionally or alternatively, the content provider may choose to select a higher priority/quality delivery method (e.g., a digital TV broadcast) for particular content only if a sufficient (e.g., threshold) number of premium end-users request that particular content.

Thus, in light of the content provider's costs and other logistical considerations (e.g., a limited number of digital TV broadcast channels), it may be helpful for the content provider to select a content delivery method based on demand for particular content by a plurality of end users. Moreover, the determination of demand for particular content may consider one or more criteria (e.g., the number of requests from end users, whether the end users are premium end users, and/or the urgency with which the end users want to receive the particular content). Accordingly, the operations described herein may improve the efficiency with which content providers deliver content to end users.

Operations of Selecting Between a Plurality of Content Delivery Methods

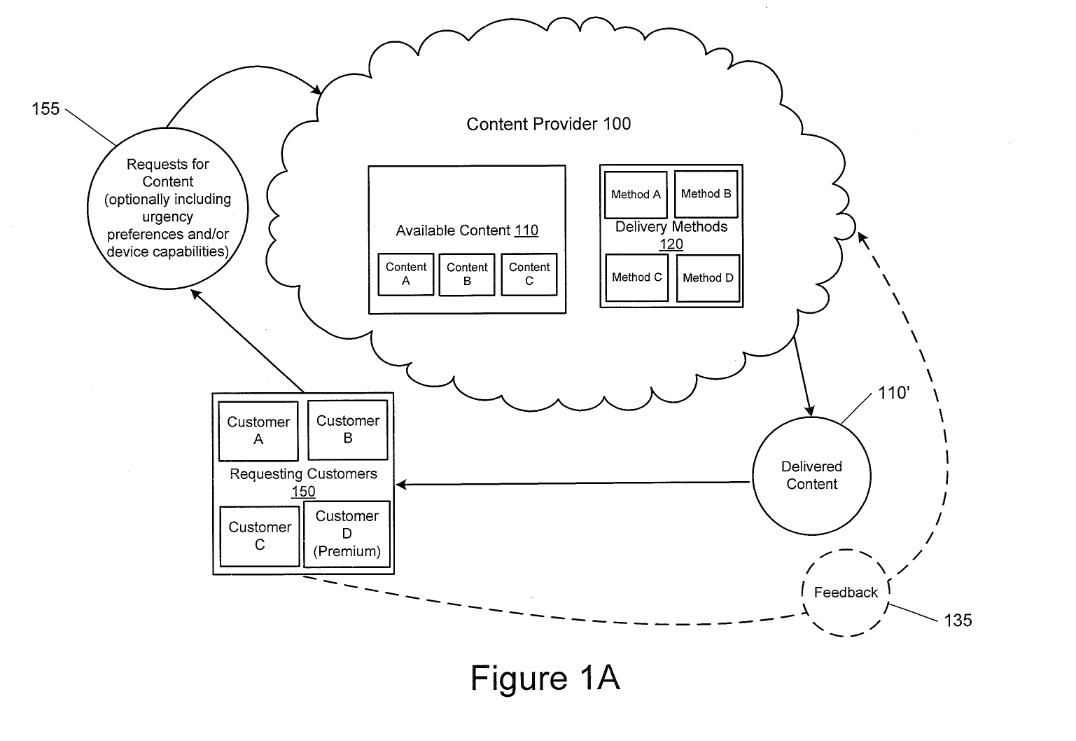

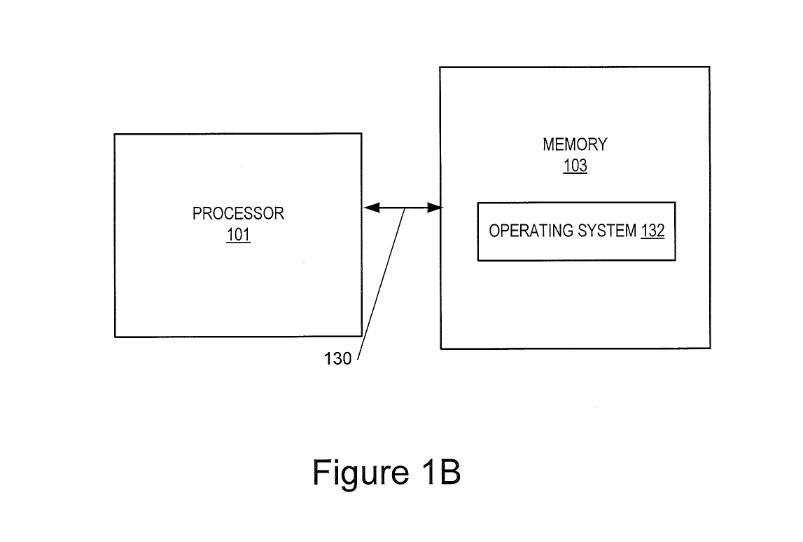

Now referring to FIG. 1A, a content provider 100 is illustrated along with a plurality of requesting customers 150 and a plurality of requests for content 155. For example, the requesting customers 150 may be end users using respective electronic devices to submit the requests 155 to the content provider 100. The content provider 100 may have a plurality of items of available content 110, such as content A-C, that the content provider 100 can provide to the requesting customers 150. The content A-C may be any type of media content (e.g., movies, music, TV shows/programs (including live/recorded sporting events, among other shows/programs), photos, books, video games, and the like). For example, the content A may be a new movie release, whereas the content B may be an older movie, and the content C may be yet another movie or even a different type of media content (e.g., a song, a book, or a game). The requesting customers 150 may include customers A-D, which may be individual persons, individual groups (e.g., companies), individual user identifications (e.g., email addresses or log-in identifications), or individual devices. Customers A-D may individually, electronically request (via respective requests 155) one or more of the content A-C. Moreover, although four (4) customers A-D and three (3) items of content A-C are illustrated in FIG. 1A, it will be understood that the numbers of requesting customers 150 and/or items of available content 110 may be much greater (e.g., dozens, hundreds, thousands, millions, etc.)

The content provider 100 will meet the requests 155 by sending delivered content 110′ to the requesting customers 150 using the delivery methods 120. For example, delivery method A may be the Internet, method B may be a digital TV broadcast channel, method C may be a forward link of a mobile (e.g., cellular) network, and method D may be mail (or another “shipping” method). As an example, the content provider 100 may deliver the content A to customer A using method A, and may deliver the content C to customer D using method B.

Moreover, it should be noted that content 110′ that is delivered over the digital TV broadcast channel may be viewed in real time by the requesting customers 150 or may be stored by the requesting customers 150 on their local receiving devices for future viewing. Additionally, the content 110′ that is delivered over the digital TV broadcast channel is delivered without contention (e.g., it is the exclusive content delivered via the digital TV broadcast channel at that time). On the other hand, content 110′ delivered over the Internet is delivered with contention because a plurality of media content items (e.g., multiple ones of content A, content B, and content C) may delivered simultaneously over the Internet.

Accordingly, the content provider 100 may want to receive feedback 135 from the requesting customers 150 regarding the quality of service for the delivered content 110′. For example, the feedback 135 may inform the content provider 100 as to whether the delivered content 110′ was successfully received by the requesting customers 150. In another example, the feedback 135 may inform that content provider 100 that the quality of the delivered content 110′ is unsatisfactory (e.g., customer C may have a poor Internet connection).

FIG. 1B is a block diagram that illustrates details of a processor and memory that may be used in accordance with embodiments of the present disclosure. In particular, FIG. 1B illustrates a processor 101 and memory 103 that may be used by the content provider 100 to perform one or more of the operations described herein (e.g., in FIGS. 1A and 2-6), according to some embodiments of the present invention. The processor 101 communicates with the memory 103 via an address/data bus 130. The processor 101 may be, for example, a commercially available and/or custom microprocessor. Moreover, it will be understood that the processor may include multiple processors. The memory 103 is representative of the overall hierarchy of memory devices containing the software and data used to implement various operations for, for example, the content provider 100 as described herein. As another example, the memory 103 may be used to implement various operations of an electronic device (e.g., a mobile/customer terminal, laptop/desktop/netbook computer, media player, television, etc.) used by one of the requesting customers 150 to submit one of the requests 155 and/or to receive/display the delivered content 110′. The memory 103 may include, but is not limited to, the following types of devices: cache, ROM, PROM, EPROM, EEPROM, flash, SRAM, and DRAM.

As shown in FIG. 1B, the memory 103 may store various categories of software and data, such as an operating system 132. For example, the operating system 132 may control operations of a device/system (e.g., a server or group of servers) of the content provider 100 that executes one or more of the operations illustrated in FIGS. 1A and 2-6. In particular, the operating system 132 may manage the resources of the device/system of the content provider 100 and may coordinate execution of various programs by the processor 101.

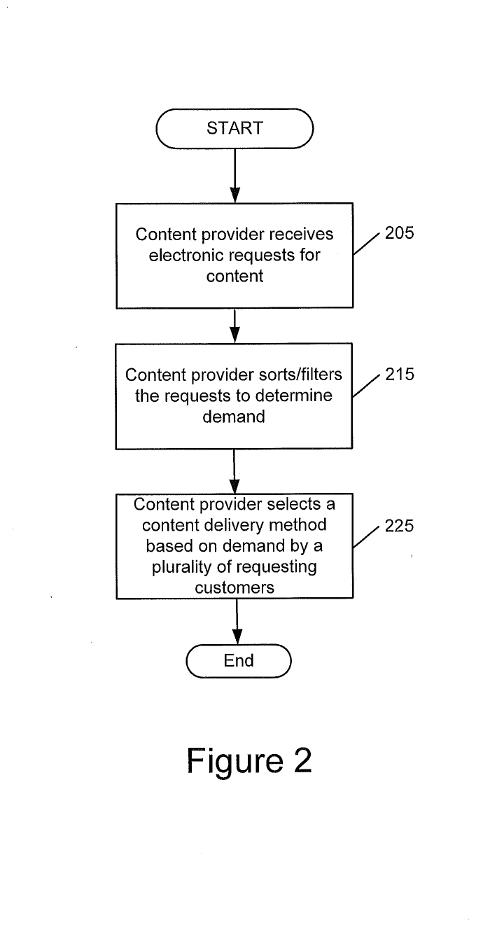

Referring now to FIG. 2, operations of selecting a content delivery method 120 are provided. Block 205 of FIG. 2 illustrates that a content provider, such as the content provider 100 of FIG. 1A, receives electronic requests for content (e.g., the requests 155 of FIG. 1A). After receiving the requests 155, the content provider 100 processes (e.g., sorts/filters) the requests 155 (Block 215). For example, the content provider 100 may sort/filter the requests 155 based on the number of requests 155 for the available content 110 (e.g., the respective number of requests for each of the content A, content B, and content C).

Additionally or alternatively, the content provider 100 may sort/filter the requests 155 based on the profile of the requesting customers 150 and/or based on the urgency of the requests 155. For example, the requests 155 may include respective indications of the requesting customers' 150 urgency and/or profile. As an example, referring back to FIG. 1A, customer D may have a profile that includes premium/preferred customer status, which profile may be indicated in customer D's request 155 that is provided to the content provider 100. Accordingly, demand may be determined for the available content 110 based on the number of requests 155, the profile of the requesting customers 150, and/or the urgency of the requests 155.

Referring still to FIG. 2, in response to the demand for a particular one of the available content 110, the content provider 100 selects one of the delivery methods 120 (Block 225). For example, the content provider 100 may provide method A only for the available content 110 that receives the highest demand.

Additionally or alternatively, the content provider 100 may deliver a portion of a particular one of the available content 110 via one of the delivery methods 120, and may deliver another portion of the particular one of the available content 110 via a different one of the delivery methods 120. For example, a first portion (e.g., quarter, third, half, etc.) of the content A may be delivered via method A and a second portion of the content A may be delivered via method B. Accordingly, different portions of the content A may be delivered via different delivery methods 120. Additionally, in some embodiments, the size of the portions delivered may be different for different delivery methods 120. In other words, a larger portion of the content A may be delivered via method A than the portion of the content A that is delivered via method B, or vice versa. Moreover, the requesting customers 150 may receive the content A using devices that are configured to receive the different portions of the content A and then reassemble the different portions of the content A as the whole content A (e.g., an entire movie).

Furthermore, the content A may be delivered in the different portions via the different delivery methods 120 in response to demand and/or content availability. For example, the content A may be delivered in different portions via different delivery methods 120 in response to determining that demand for the content B is higher than demand for the content A. In such an example, the content B may be delivered exclusively via the method A, whereas the content A is partially delivered via the method A (or the method C) and partially delivered via the method B.

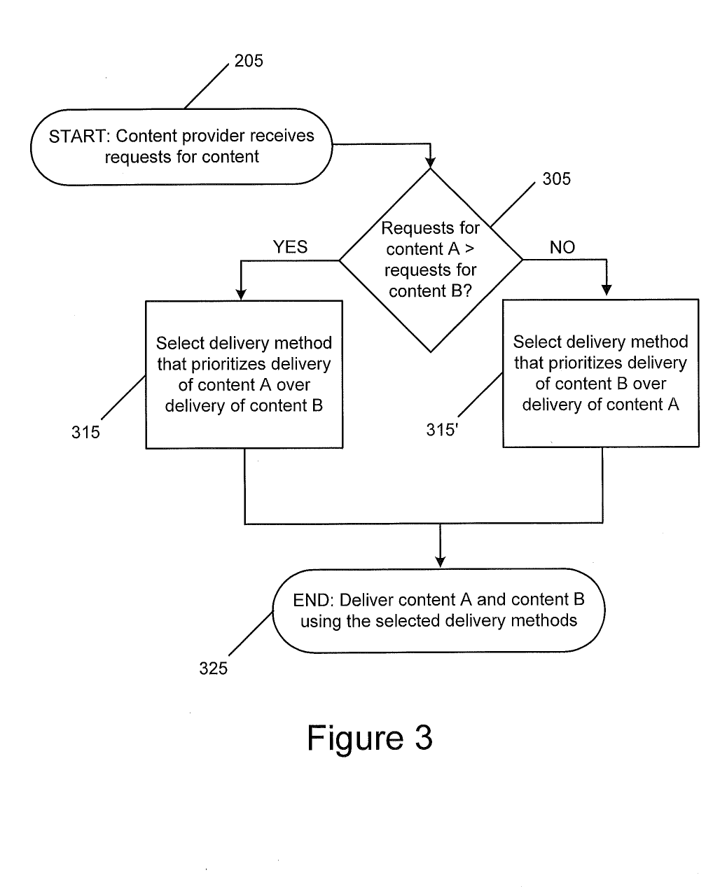

Referring now to FIG. 3, a flowchart is provided to illustrate operations of selecting a content delivery method 120 based on demand, according to some embodiments. The demand may be determined using customer requests (e.g., the requests 155 received in Block 205 of FIG. 2). In particular, FIG. 3 illustrates selecting the content delivery method 120 based on whether the content A or the content B receives the most requests 155 from requesting customers 150 (Block 305). The number of requests 155 may be defined as the raw number of received requests or may be an adjusted total that only includes received requests from requesting customers 150 that are capable of receiving the delivered content 110′ via all of the delivery methods 120. In other words, a requesting customer 150 who can only receive the delivered content 110′ by mail may be excluded from the total. Additionally, in some embodiments, the total may be adjusted by weighting some requesting customers 150 (e.g., preferred or premium customers) more heavily than others.

Referring still to FIG. 3, if the number of requests 155 for the content A is greater than the number of requests 155 for the content B, then the content provider 100 selects a delivery method 120 that prioritizes the delivery of content A over the delivery of content B (Block 315). In other words, if method A is a higher priority delivery method 120 than method B, then the higher-demand content A will be delivered using method A and the lower-demand content B will be delivered using method B (Block 325). Alternatively, if the number of requests 155 for the content A is smaller than the number of requests 155 for the content B, then the content provider 100 selects a delivery method 120 that prioritizes the delivery of content B over the delivery of content A (Block 315′).

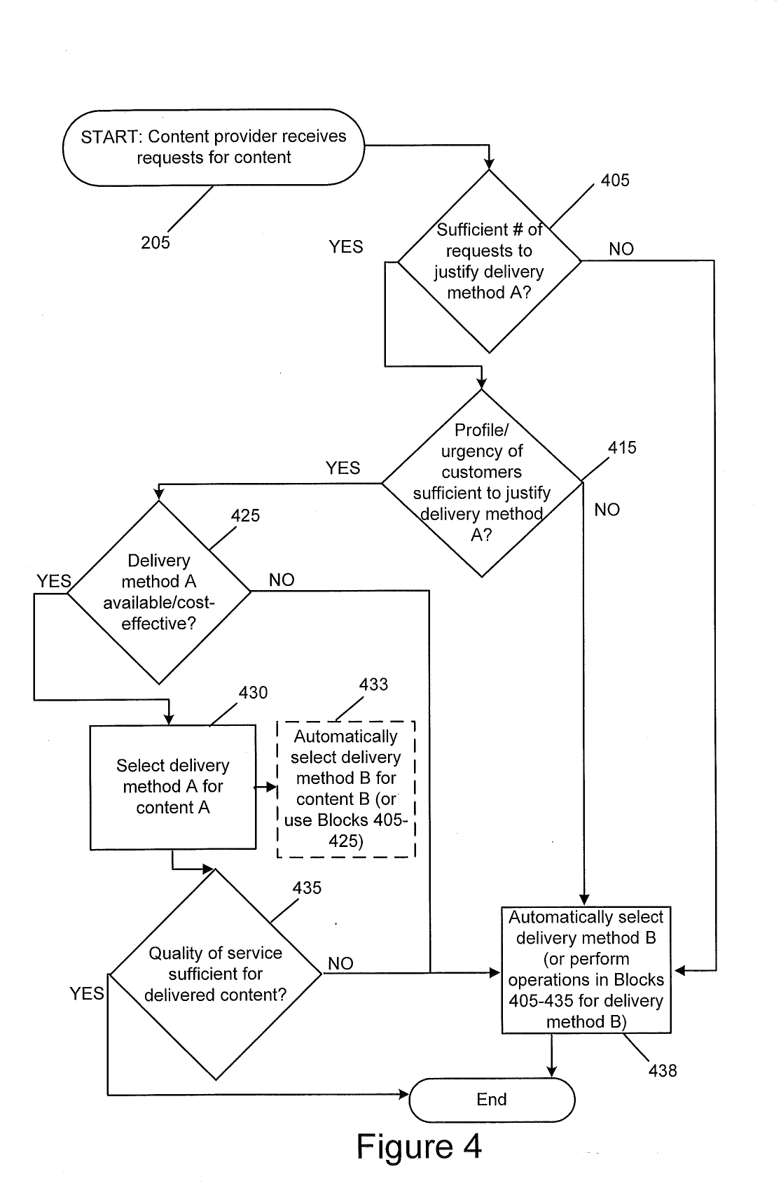

Referring now to FIG. 4, a flowchart is provided to illustrate operations of selecting a content delivery method 120 based on demand, according to some embodiments. The demand may be determined using customer requests (e.g., the requests 155 received in Block 205 of FIG. 2). Block 405 of FIG. 4 illustrates determining whether a sufficient number of requests 155 has been received by the content provider 100 to justify delivery of a particular item of available content 110 using a particular delivery method 120 (e.g., the highest priority method A). For example, this determination may be a comparison between the number of requests 155 for different ones of the content A-C. Additionally or alternatively, this determination may include determining whether a threshold number of requests 155 have been made. For example, the content provider 100 may only use method A if at least ten thousand (10,000) requesting customers 150 request a particular one of the content A-C. As illustrated in Block 438, if an insufficient number of requests 155 is received, then the content provider 100 may either automatically select another delivery method 120 (e.g., method B) for the particular one of the content A-C or may repeat the decision process in Block 405 (as well as the subsequent blocks 415-435) with respect to another delivery method 120 to determine whether the other delivery method 120 is appropriate for the particular one of the content A-C. For example, the operations in Blocks 405-435 might be used with respect to content A for two, three, or all of the methods A-D rather than just for the method A.

Referring still to FIG. 4, if a sufficient number of requests 155 is received to justify delivery method A (Block 405), then a determination is made as to whether the profile (e.g., status and/or device capabilities) and/or urgency/readiness of the requesting customers 150 is sufficient to justify delivery method A (Block 415). For example, the content provider 100 may adjust the number of requests 155 based on whether those requests 155 are from requesting customers 150 who have a premium or preferred status (e.g., based on whether those customers 150 pay more than others or whether those customers 150 are heavy or light users of content 110).

Alternatively, the content provider 100 may require a threshold number of requests 155 from premium/preferred status requesting customers 150 to select method A. Moreover, it will be understood that Blocks 405 and 415 may be combined into a single operation/determination. For example, determining whether a sufficient number of requests 155 has been received to justify delivery method A may include weighting the number of requests 155 for customers 150 having premium or preferred status.

Additionally, the content provider 100 may determine whether a particular delivery method 120 is available (Block 425). For example, method A (e.g., a digital TV broadcast channel) may be unavailable on a given evening but may be available after midnight. Similarly, method C (e.g., a forward link of a mobile network) may be unavailable during peak usage hours. In some embodiments, Block 425 may additionally or alternatively include determining whether providing the particular delivery method 120 is cost-effective to the content provider 100 in light of the demand from the customers 150. For example, the content provider 100 may determine whether delivery method A is more cost-effective than delivery method B for a particular one of the available content 110 in light of the revenue the content provider 100 may generate and/or the costs the content provider 100 may incur by selecting delivery method A.

After performing the decision processes illustrated in Blocks 405, 415, and 425, a particular delivery method 120 may be selected for one of the available content 110 that is requested. For example, as illustrated in Block 430, method A may be selected for delivering content A, after performing the decision processes in Blocks 405-425 for content A with respect to method A. Additionally, assuming that method A is selected for delivering content A, then this selection may further result in the automatic selection of method B for delivering content B (Block 433). Alternatively, Block 433 further illustrates that the decision processes in Blocks 405, 415, and 425 may be carried out for content B with respect to method B instead of automatically selecting method B. In other words, these decision processes may be carried out for content B with respect to method B in response to selecting method A for delivering content A.

Moreover, even if the content provider 100 selects a particular delivery method 120, a determination may be made regarding whether the quality of service is sufficient for the delivered content 110′ (Block 435). This determination may be made before and/or after delivering the content 110′. For example, the content provider 100 may use the feedback 135 (illustrated in FIG. 1A) to determine that a particular requesting customer's 150 Internet connection or mobile network signal reception is poor, and that a different delivery method 120 should be selected.

One of the Blocks 415, 425, or 435 of FIG. 4 may also include a determination regarding whether a particular requesting customer 150 is ready to receive the requested content 110 in real time (e.g., substantially immediately) or is requesting delivery to meet a future viewing need. This could be ascertained in multiple ways, such as by (A) a direct question presented to the customer 150 by the content provider 100 or by (B) a behavior-prediction algorithm (e.g., someone ordering from a non-home Internet Protocol (IP) address at 7:45 AM is probably pre-ordering content 110 for use after returning home from work). The content provider 100 may therefore use a variety of approaches to determine if the requesting customer 150 does not want (or does not have the capability) to receive the content 110 until after some delay of time (e.g., a few minutes or hours or even a few days or weeks). Accordingly, the content provider 100 may adjust the number of requests 155 (e.g., in Block 405 and/or Block 415) based on the customer's 150 urgency/readiness to receive the requested content 110.

The selection of a content delivery method 120 may also account for the cost of a particular delivery method 120 (i.e., the cost to the content provider 100). For example, the cost to the content provider 100 for a mobile network forward link delivery method (e.g., method C) may be higher than the cost for a digital TV broadcast channel delivery method (e.g., method A) or an Internet delivery method (e.g., method B). As such, the content provider 100 may select less costly content delivery methods 120 before considering the mobile network forward link (e.g., method C), even if a sufficient number of requesting customers 150 would otherwise be able to receive content 110 using the mobile network forward link.

Additionally, in some embodiments, the content provider 100 may select the delivery method 120 based upon customer 150 cost characteristics. For example, some Internet Service Providers (ISPs) and mobile carriers have introduced usage caps and charges for exceeding the caps. Accordingly, if the customer 150 uses a significant amount of Internet or mobile services, then it may be likely that the customer 150 will exceed a usage cap and that the selected content delivery method 120 will cost the customer 150 additional usage charges. By knowing when a cap will be exceeded, the content provider 100 can factor this into its content delivery method 120 selection process. For example, the content provider 100 may choose to select a delivery method 120 that will likely result in charging the customer 150 the additional usage charges, or may alternatively choose to select a delivery method 120 that will likely keep the customer 150 below a usage cap.

Furthermore, it should be noted that Blocks 405, 415, 425, and 435 may be performed in a different order from that illustrated in FIG. 4. For example, a determination regarding whether delivery method A is available (Block 425) may be performed before a determination regarding the number of requests 155 received (Block 405). In another example, a determination regarding the quality of service (Block 435) may be made before and/or after selecting delivery method A.

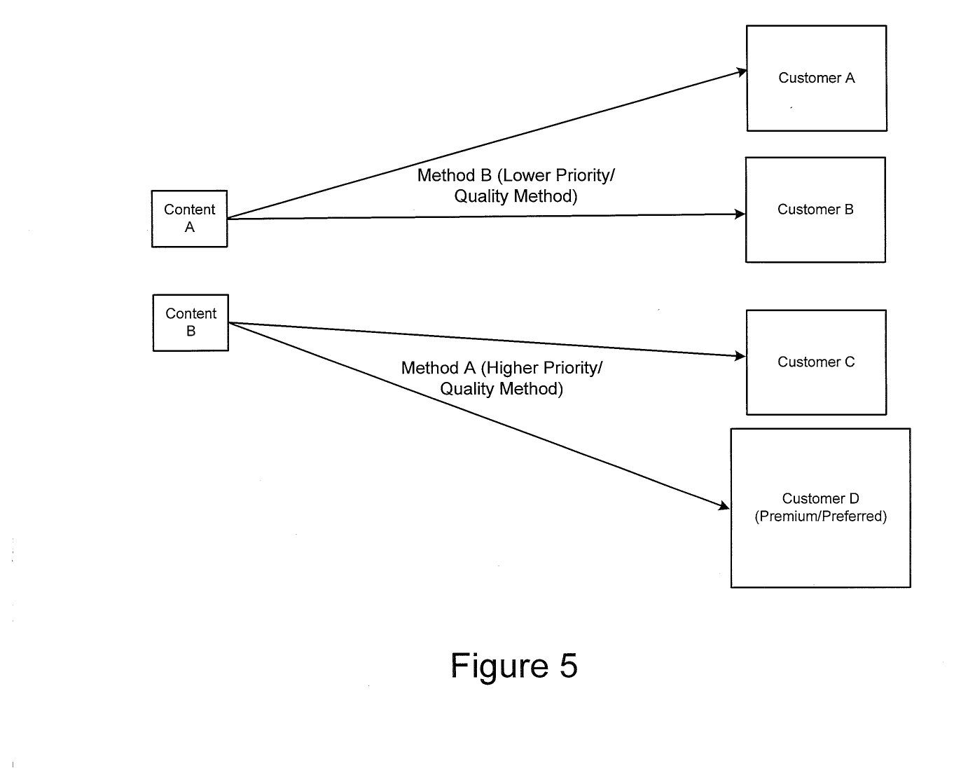

Now referring to FIG. 5, a schematic diagram is provided illustrating content delivery via two different methods 120, according to various embodiments herein. In particular, FIG. 5 illustrates a selection of delivery method A to deliver content B, which selection is in response to determining that demand for content B is higher than demand for content A. For example, FIG. 5 illustrates that demand for content B is higher than demand for content A because, although content A and content B have each received the same number (two (2)) of customer requests, customer D's premium/preferred status adds weight to the customer requests received for content B. Moreover, it will be understood that demand for content B may additionally or alternatively be determined to be higher than demand for content A if a third customer (e.g., customer E) requests content B and thereby provides content B with more customer requests (three (3)) than content A has received.

The delivery method A illustrated in FIG. 5 may provide higher media content quality than delivery method B and/or may receive a higher priority from the content provider 100 than delivery method B. For example, delivery method A may provide a higher video resolution, fewer transmission interruptions, a more popular viewing time of the day/week (e.g., primetime viewing), and/or a customer-preferred physical medium, in comparison with delivery method B. Moreover, in some embodiments, the lower quality/priority delivery method B may be automatically selected for delivery of the lower-demand content A by a processor 101 of the content provider 100 in response to selection of the higher quality/priority delivery method A for delivery of the more-highly-demanded content B. Alternatively, it will be understood that the operations described herein may be performed with respect to additional delivery methods 120 (e.g., delivery method C and/or delivery method D) before pairing the delivery methods 120 with respective available content 110.

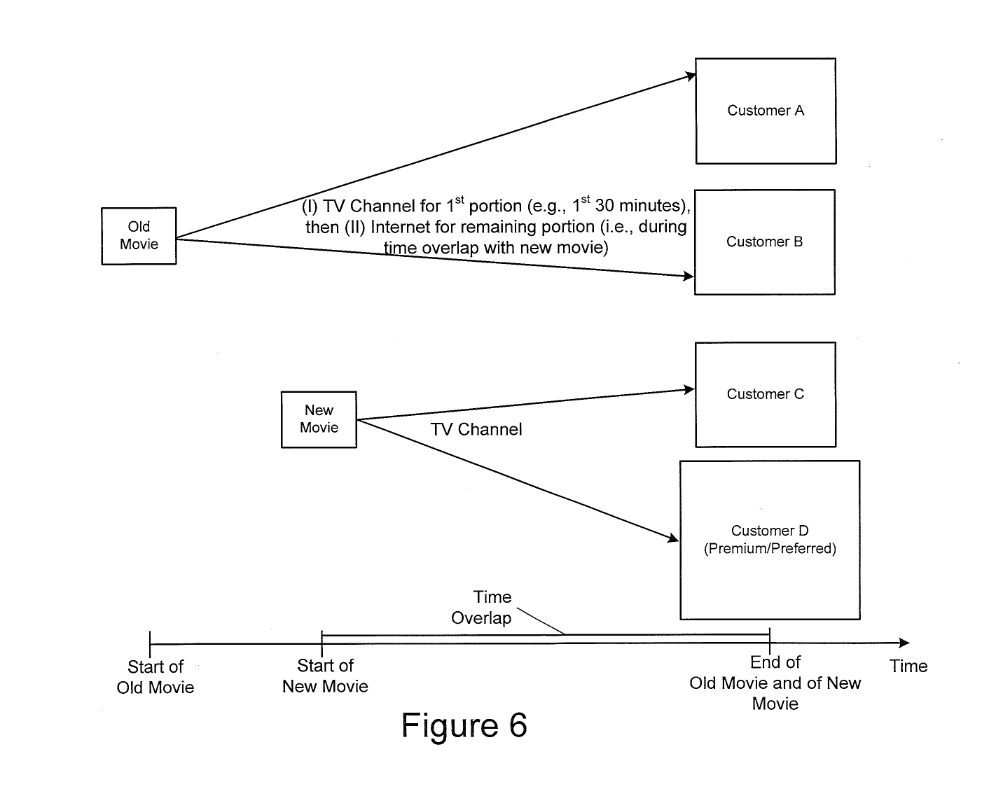

Now referring to FIG. 6, a schematic diagram is provided illustrating content delivery of different portions of a movie via two different methods 120, according to various embodiments herein. In particular, FIG. 6 illustrates a modification of FIG. 5 in which the lower-demand content A and the higher-demand content B are an older movie and a newer movie, respectively, and delivery methods A and B are (a) a TV channel and (b) a combination of the TV channel and the Internet, respectively. In other words, FIG. 6 illustrates an example in which the older movie, which is video content receiving lower customer demand than the newer movie, may be delivered partially by the higher quality/priority delivery method A and partially by the lower quality/priority delivery method B. As an example, the content provider 100 may provide the newer movie exclusively via the TV channel during primetime viewing, and may deliver a portion (e.g., the first thirty (30) minutes) of the older movie via the same TV channel before presenting the newer movie and then deliver the remaining portion of the older movie via the Internet and/or a forward link of a mobile network. It will be understood, however, that a portion of the older movie may be delivered via the TV channel during any non-overlapping time with respect to the newer movie (i.e., before and/or after delivery/presentation of the newer movie). Furthermore, it will be understood that although the older and newer movies are described herein as examples of different video content, further examples of video content may include TV programs and sporting events.

Accordingly, some of the embodiments herein provide for selecting between a plurality of content delivery methods 120 in response to demand for particular media content 110 (e.g., content A) by a plurality of customers 150. The demand may be determined based solely on the number of customers 150 requesting content A or may be adjusted based on a variety of additional factors. For example, the demand may be adjusted based on real-time feedback 135 and/or weight(s) assigned (e.g., based on profile) to the requesting customers 150. In another example, the selection between the plurality of content delivery methods 120 is in response to both the number of customers 150 requesting the particular media content 110 and the readiness/preferences of the plurality of customers 150 regarding how quickly (e.g., immediately vs. hours vs. days) the particular media content 110 (e.g., content A) is delivered. It should be noted that the different delivery methods 120 may each use a different physical medium (e.g., a movie streaming over the Internet vs. a movie on a DVD, a TV channel, or a forward link of a mobile network). Moreover, the selection between the plurality of content delivery methods 120 may account for monetary and/or logistical costs to the content provider 100 and/or the requesting customers 150. The operations described herein therefore may improve the efficiency with which a content provider 100 delivers content 110 to requesting customers 150.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of all combinations and subcombinations of the embodiments described herein, and of the manner and process of making and using them, and shall support claims to any such combination or subcombination.

In the drawings and specification, there have been disclosed example embodiments of the invention. Although specific terms are employed, they are used in a generic and descriptive sense only and not for purposes of limitation, the scope of the invention being defined by the following claims.

What is claimed is:

1. A process of selecting a content delivery method, the process comprising:
electronically receiving a plurality of requests from a plurality of customers, respectively, for a first media content and/or a second media content;
comparing demand for the first media content by the plurality of customers with demand for the second media content by the plurality of customers using the plurality of requests;
selecting a first content delivery method for the first media content in response to determining that the demand for the first media content is greater than the demand for the second media content; and
selecting a second content delivery method for the second media content.

2. The process of claim 1, wherein:
comparing demand comprises comparing a quantity of the plurality requests for the first media content with a quantity of the plurality of requests for the second media content; and
the process further comprises electronically delivering the first and second media content during respective time periods that at least partially overlap.

3. The process of claim 2, further comprising:
determining whether the quantity of the plurality of requests for the first media content meets a threshold number corresponding to the first content delivery method,
wherein selecting the first content delivery method further comprises selecting the first content delivery method for the first media content in response to determining that the quantity of the plurality of requests for the first media content meets the threshold number.

4. The process of claim 2, wherein comparing demand further comprises determining:
a quantity of the plurality of requests that are from premium ones of the plurality customers; and/or
a quantity of the plurality of requests that are from ones of the plurality of customers urgently requesting the first media content and/or the second media content,
wherein selecting the first content delivery method further comprises selecting the first content delivery method for the first media content in response to determining the quantity of the plurality of requests that are from premium ones of the plurality customers and/or in response to determining the quantity of the plurality of requests that are from ones of the plurality of customers urgently requesting the first media content and/or the second media content.

5. The process of claim 1, wherein selecting the first content delivery method for the first media content further comprises selecting the first content delivery method for the first media content in response to determining that a quality of service that can be provided with respect to the first media content for one or more of the plurality of customers meets a threshold.

6. The process of claim 1, further comprising:
after delivering at least a portion of the first media content via the first content delivery method, receiving real-time feedback regarding a quality of service received by one or more of the plurality of customers with respect to the delivery of the first media content; and
selecting a content delivery method that is different from the first content delivery method for the first media content for the one or more of the plurality of customers in response to determining from the real-time feedback that the quality of service fails to meet a threshold.

7. A process of selecting a content delivery method, the process comprising:
selecting between first and second content delivery methods for a particular media content in response to demand for the particular media content by a plurality of customers.

8. The process of claim 7, wherein the demand for the particular media content is determined in response to a quantity of requests for the particular media content by the plurality of customers.

9. The process of claim 7, wherein the demand for the particular media content is determined in response to preferences of the plurality of customers for how quickly the particular media content is delivered.

10. The process of claim 9, wherein the second content delivery method is a substantially time-delayed delivery method in comparison with the first content delivery method.

11. The process of claim 7, wherein the first and second content delivery methods use a different physical medium.

12. The process of claim 7, wherein the first and second content delivery methods include different methods among physical mail, Internet delivery, a television channel, or a forward link of a mobile network.

13. The process of claim 7, wherein selecting between the first and second content delivery methods comprises selecting the first content delivery method for a first portion of the particular media content and selecting the second content delivery method for a second portion of the particular media content.

14. The process of claim 13, further comprising:
delivering the first and second portions of the particular media content via the first and second content delivery methods, respectively, to an electronic device of one of the plurality of customers that is configured to reassemble the first and second portions of the particular media content to provide an entirety of the particular media content.

15. The process of claim 14, wherein the first content delivery method comprises Internet delivery and the second content delivery method comprises a television channel.

16. The process of claim 14, wherein the first content delivery method comprises Internet delivery and the second content delivery method comprises a forward link of a mobile network

17. The process of claim 13, wherein the particular media content comprises a first media content, the process further comprising:
delivering the first and second portions of the first media content via the first and second content delivery methods, respectively, and delivering a second media content exclusively via a third content delivery method in response to demand for the first and second media content.

18. The process of claim 17, wherein demand for the second media content that is delivered exclusively via the third content delivery method is higher than demand for the first media content that is delivered in the first and second portions via the first and second content delivery methods, respectively.

19. The process of claim 17, wherein:
the first and third content delivery methods comprise a same delivery method; and
the first and second content delivery methods comprise different delivery methods.

20. The process of claim 17, wherein the first, second, and third content delivery methods comprise different delivery methods.

21. The process of claim 7, wherein:
selecting between the first and second content delivery methods comprises determining the demand for the particular media content; and
determining the demand for the particular media content comprises differentiating between premium and non-premium ones of the plurality of customers.

22. The process of claim 21, wherein differentiating between premium and non-premium ones of the plurality of customers comprises weighting the premium ones of the plurality of customers more heavily than the non-premium ones of the plurality of customers with respect to determining the demand for the particular media content.

23. The process of claim 21, wherein determining the demand for the particular media content comprises determining whether a threshold number of the premium ones of the plurality of customers have requested the particular media content.

24. A content delivery system configured to perform the process of claim 7.

25. A process of selecting first and second video content delivery methods, the process comprising:
receiving requests for first video content and requests for second video content from a plurality of customers;
determining demand for the first video content by the plurality of customers and demand for the second video content by the plurality of customers using the requests for the first video content and the requests for the second video content;
selecting first and second video content delivery methods for the first and second video content, respectively, in response to the demand for the first video content and the demand for second video content.

26. The process of claim 25, wherein selecting first and second video content delivery methods for the first and second video content, respectively, comprises prioritizing delivery of the first video content over the second video content in response to determining that the demand from the first video content is greater than the demand for the second video content.

27. The process of claim 26, wherein the first video content comprises a movie or a television (TV) program and the second video content comprises a different movie or TV program.

28. The process of claim 27, further comprising electronically delivering the first and second video content during respective time periods that at least partially overlap, in response to selecting the first and second video content delivery methods.

29. The process of claim 28, wherein the first video content delivery method comprises a TV channel and the second video content delivery method comprises Internet delivery and/or a forward link of a mobile network.

30. The process of claim 29, wherein delivering the second video content comprises delivering a portion of the second video content via the second video content delivery method during the partial overlap of the time periods and delivering a different portion of the second video content via the TV channel either before or after the partial overlap of the time periods.

31. The process of claim 25, wherein:
determining the demand for the first video content and determining the demand for the second video content comprises determining quantities of requests for the first and second video content, respectively; and
selecting the first and second video content delivery methods further comprises selecting the first and second video content delivery methods in response to determining the quantities of requests.

32. The process of claim 31, wherein:
determining the demand for the first video content and determining the demand for the second video content further comprises determining quantities of premium customers requesting the first and second content, respectively; and
selecting the first and second video content delivery methods further comprises selecting the first and second video content delivery methods in response to determining the quantities of premium customers.

33. The process of claim 31, wherein:
determining the demand for the first video content and determining the demand for the second video content further comprises determining an urgency of the requests for the first video content and an urgency of the requests for the second video content; and
selecting the first and second video content delivery methods further comprises selecting the first and second video content delivery methods in response to determining the urgency of the requests.

34. The process of claim 31, wherein:
determining the demand for the first video content and determining the demand for the second video content further comprises:
determining quantities of premium customers requesting the first and second content, respectively; and
determining an urgency of the requests for the first video content and an urgency of the requests for the second video content; and
selecting the first and second video content delivery methods further comprises selecting the first and second video content delivery methods in response to determining the quantities of premium customers and/or in response to determining the urgencies of the requests.

35. The process of claim 31, wherein:
determining the demand for the first video content and determining the demand for the second video content further comprises determining which of the plurality of customers is capable of receiving video content via both of the first and second video content delivery methods; and
selecting the first and second video content delivery methods further comprises selecting the first and second video content delivery methods in response to determining which of the plurality of customers is capable of receiving video content via both of the first and second video content delivery methods.

36. The process of claim 25, further comprising selecting the first and second video content delivery methods for the first and second video content, respectively, in response to determining that selecting the first video content delivery method for the first video content is more cost-effective for a content provider of the first video content than selecting the second video content delivery method for the first video content.
